(19) United States
(12) Patent Application Publication
(10) Pub. No.: US 2024/0280812 A1
(43) Pub. Date: Aug. 22, 2024

(54) HEAD MOUNTED DEVICE AND OPERATING METHOD FOR HEAD MOUNTED DEVICE

(71) Applicant: Innolux Corporation, Miaoli County (TW)

(72) Inventors: Chien-Chih Liao, Miaoli County (TW); Hsing-Yuan Hsu, Miaoli County (TW); Po-Yang Chen, Miaoli County (TW); I-AN YAO, Miaoli County (TW)

(73) Assignee: Innolux Corporation, Miaoli County (TW)

(21) Appl. No.: 18/409,791

(22) Filed: Jan. 11, 2024

Related U.S. Application Data
(60) Provisional application No. 63/447,352, filed on Feb. 22, 2023.

(30) Foreign Application Priority Data
Sep. 18, 2023 (CN) 202311202996.X

(51) Int. Cl. G02B 27/01

(52) U.S. Cl. CPC G02B 27/017; G02B 2027/0138; G02B 2027/014

(57) ABSTRACT

A head mounted device and an operating method for the head mounted device are provided. The head mounted device includes a display unit, a first sensing device and a second sensing device. The display unit displays an image. The first sensing device detects whether there is an object causing harm to the user within a specific range. The second sensing device captures an object image of the object, so that the display unit displays the object image.

### CROSS-REFERENCE TO RELATED APPLICATION

This application claims the priority benefit of U.S. provisional application Ser. No. 63/447,352, filed on Feb. 22, 2023 and China application serial no. 202311202996.X, filed on Sep. 18, 2023. The entirety of each of the above-mentioned patent applications are hereby incorporated by reference herein and made a part of this specification.

### BACKGROUND

### Technical Field

The disclosure relates to an electronic device and an operating method for the electronic device, and in particular relates to a head mounted device and an operating method for the head mounted device.

### Description of Related Art

Users may enjoy audio-visual entertainment or play games through head mounted devices. The head mounted device is, for example, a head mounted display. When a user enjoys audio-visual entertainment or plays games through a head mounted device, the user cannot know about the conditions of the environment around the user. It may be seen from this that the user who is using the head mounted device has no way of knowing that the user himself may be exposed to danger. Therefore, how to provide a head mounted device that may detect whether there is an object causing harm to the user is one of the research focuses of those skilled in the art.

### SUMMARY

A head mounted device and an operating method for the head mounted device, which may detect whether there is an object causing harm to a user, are provided in the disclosure.

According to an embodiment of the disclosure, a head mounted device is worn on a user and provides an image to the user. The head mounted device includes a display unit, a first sensing device, and a second sensing device. The display unit displays the image. The first sensing device detects whether there is an object causing harm to the user within a specific range. The second sensing device captures an object image of the object, so that the display unit displays the object image.

According to embodiments of the disclosure, an operating method is configured for a head mounted device. The head mounted device is worn on a user and provides an image to the user. The head mounted device includes a display unit, a first sensing device, and a second sensing device. The operating method includes the following operation. Whether there is an object causing harm to the user within a specific range is detected by the first sensing device. An object image of the object is captured by the second sensing device when the object causing harm to the user is detected within the specific range. The display unit is controlled to display the object image.

Based on the above, in this disclosure, whether there is an object causing harm to the user within a specific range is detected by the first sensing device. When an object causing harm to the user within the specific range is detected, the display unit displays the object image of the object. In this way, the head mounted device may know about that there is an object causing harm to the user within a specific range, and display the object image of the object through the display unit. The usage safety of the head mounted device may be improved.

### BRIEF DESCRIPTION OF THE DRAWINGS

FIG. 1 is a usage scenario diagram of a head mounted device according to an embodiment of the disclosure.

FIG. 2 is a schematic diagram of a head mounted device according to an embodiment of the disclosure.

FIG. 3 is a flowchart of an operating method according to an embodiment of the disclosure.

FIG. 4 is a schematic diagram of a processor according to an embodiment of the disclosure.

FIG. 5 is a flowchart of an operating method according to an embodiment of the disclosure.

FIG. 6 is a flowchart of an operating method according to an embodiment of the disclosure.

FIG. 7 is a schematic diagram of a head mounted device according to an embodiment of the disclosure.

FIG. 8 is a schematic diagram of a head mounted device according to an embodiment of the disclosure.

FIG. 9 is a schematic diagram of a display unit and a first sensor according to an embodiment of the disclosure.

FIG. 10 is a schematic diagram of a display unit and a first sensor according to an embodiment of the disclosure.

FIG. 11 is a schematic diagram of a display unit and a mask according to an embodiment of the disclosure.

FIG. 12A and FIG. 12B are respectively schematic diagrams of a display unit, a first sensor, and a mask according to an embodiment of the disclosure.

### DETAILED DESCRIPTION OF DISCLOSED EMBODIMENTS

The disclosure may be understood by referring to the following detailed description in conjunction with the accompanying drawings as described below. It should be noted that, for purposes of clarity and easy understanding by readers, each drawing of the disclosure depicts a part of an electronic device, and some components in each drawing may not be drawn to scale. In addition, the number and size of each device depicted in the drawings are illustrative only and not intended to limit the scope of the disclosure.

Certain terms are used throughout the description and claims below to refer to specific components. It should be understood by those skilled in the art, manufacturers of electronic equipment may refer to components by different names. The disclosure does not intend to distinguish between components that differ in name but not function. In the following description and in the claims, the terms “comprising”, “including”, and “having” are used in an open-ended manner, and should therefore be construed to mean “including but not limited to . . . ”, therefore, when the terms “comprising”, “including”, and/or “having” are used in the description, it indicates the existence of corresponding features, regions, steps, operations, and/or components, but are not limited to the existence of one or more corresponding features, regions, steps, operation, and/or components.

It should be understood that when a component is referred to as being “coupled to”, “connected to”, or “conducted to” another component, the component may be directly connected to another component and an electrical connection may be established directly, or there may be an intermediate component between these components for a relay electrical connection (indirect electrical connection). In contrast, when a component is referred to as being “directly coupled to,” “directly connected to”, or “directly connected to” another component, there are no intermediate components present.

Although terms such as first, second, third, etc. may be used to describe various constituent components, such constituent components are not limited by these terms. The terms are only used to distinguish a constituent component from other constituent components in the specification. Claims may not use the same terms, but may use the terms first, second, third, etc. with respect to the required order of the components. Therefore, in the following description, the first constituent component may be the second constituent component in the claims.

The electronic device of the disclosure may include a display unit, an antenna device, a sensing device, a light-emitting device, a touch display device, a curved display device, or a free shape display, but not limited thereto. The electronic device may include a bendable or flexible electronic device. The electronic device may, for example, comprise liquid crystal, light-emitting diode, quantum dot (QD), fluorescence, phosphor, other suitable display materials, or a combination of the materials thereof, but not limited thereto. The light emitting diode may include, for example, an organic light-emitting diode (OLED), a mini light emitting diode (mini LED), a micro light emitting diode (micro LED), or a quantum dot light emitting diode (quantum dot LED, which may include QLED, QDLED), or other suitable materials, or a combination thereof, but not limited thereto. The display device may include, for example, but not limited to, a spliced display device. The antenna device may be, for example, a liquid crystal antenna, but not limited thereto. The antenna device may, for example, include an antenna splicing device, but not limited thereto. It should be noted that, the electronic device may be any arrangement and combination of the foregoing, but not limited thereto. In addition, the shape of the electronic device may be rectangular, circular, polygonal, a shape with curved edges, or other suitable shapes. The electronic device may have peripheral systems such as a driving system, a control system, a light source system, etc. to support a display device, an antenna device, or a spliced device, but the disclosure is not limited thereto. The sensing device may include a camera, an infrared sensor, or a fingerprint sensor, etc., and the disclosure is not limited thereto. In some embodiments, the sensing device may further include a flash, an infrared (IR) light source, other sensors, electronic components, or a combination thereof, but not limited thereto.

In the disclosure, the embodiments use “pixel” or “pixel unit” as a unit for describing a specific region including at least one functional circuit for at least one specific function. The region of the ‘pixels’ depends on the unit configured to provide a specific function, adjacent pixels may share the same parts or wires, but may also contain specific parts within themselves. For example, adjacent pixels may share the same scan line or the same data line, but a pixel may also have its own transistors or capacitors.

It should be noted that technical features in different embodiments described below may be replaced, reorganized or mixed with each other to form another embodiment without departing from the spirit of the disclosure.

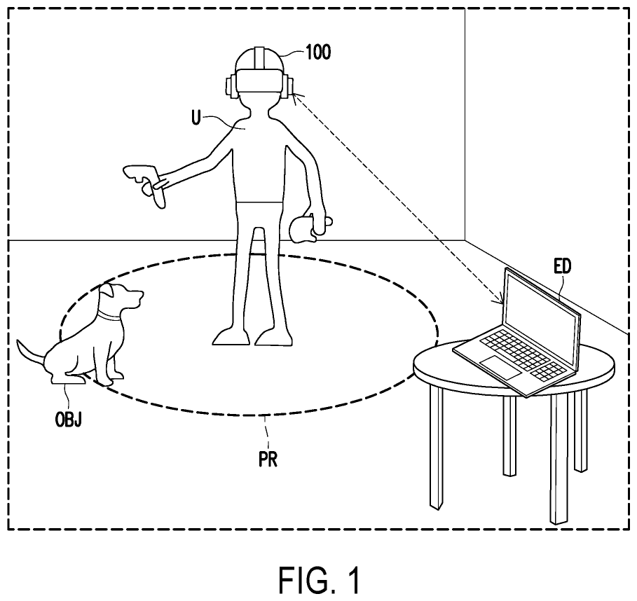

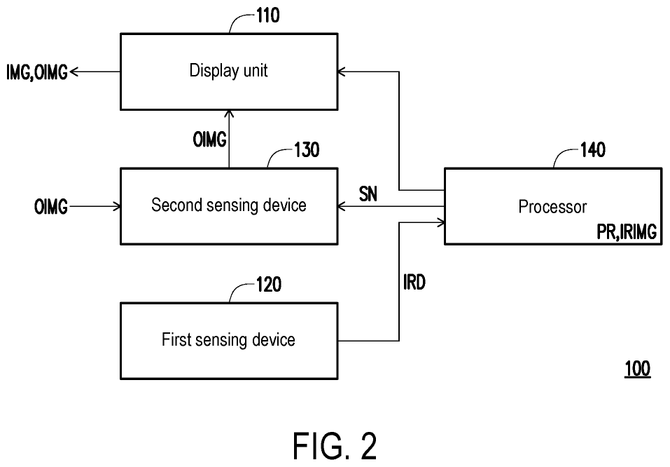

Referring to FIG. 1 and FIG. 2 at the same time, FIG. 1 is a usage scenario diagram of a head mounted device according to an embodiment of the disclosure. FIG. 2 is a schematic diagram of a head mounted device according to an embodiment of the disclosure. In this embodiment, a head mounted device (HMD) 100 is worn on the user U and provides an image IMG to the user U. The head mounted device 100 is, for example, any form of head mounted display device. In this embodiment, the head mounted device 100 includes a display unit 110, a first sensing device 120, and a second sensing device 130. The display unit 110 displays the image IMG. The first sensing device 120 detects whether there is an object OBJ causing harm to the user U within a specific range PR. The second sensing device 130 captures an object image OIMG of the object OBJ, so that the display unit 110 displays the object image OIMG.

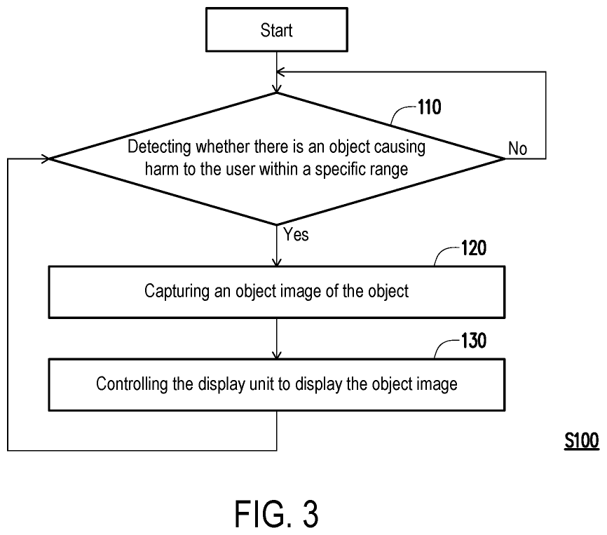

Referring to FIG. 1, FIG. 2, and FIG. 3 at the same time, FIG. 3 is a flowchart of an operating method according to an embodiment of the disclosure. In this embodiment, the operating method S100 is configured for the head mounted device 100. The operating method S100 includes steps S110 to S130. The user U enjoys audio-visual entertainment or plays games through the head mounted device 100. The first sensing device 120 starts to detect the environment around the user U. During use, the first sensing device 120 detects in step S110 whether there is an object OBJ that may cause harm to the user U within the specific range PR. When the first sensing device 120 detects that there is an object OBJ causing harm to the user U within the specific range PR, the second sensing device 130 captures the object image OIMG of the object OBJ in step S120. Next, the head mounted device 100 controls the display unit 110 to display the object image OIMG of the object OBJ in step S130. After step S130, the operating method S100 returns to the operation of step S110.

It is worth mentioning here that during use, the head mounted device 100 may detect the object OBJ causing harm to the user within a specific range PR, and display the object image OIMG through the display unit 110. In this way, the usage safety of the head mounted device 100 may be improved.

On the other hand, in step S110, when the first sensing device 120 does not detect the object OBJ causing harm to the user U within the specific range PR, the first sensing device 120 continues to detect in step S110 whether there is an object OBJ that may cause harm to the user U within the specific range PR.

In this embodiment, the first sensing device 120 is an infrared detection device. The first sensing device 120 is, for example, a long-wave infrared (LWIR) detection device. The specific range PR may be the physical activity range centered on the user U (however, this disclosure is not limited thereto). Therefore, the physical activity range of the user U is set to the specific range PR. The specific range PR may move as the user U moves. In this embodiment, the area of the specific range PR may be determined according to the detection distance of the first sensing device 120, alternatively, the user U may set the area range of the specific range PR in the head mounted device 100.

In this embodiment, the head mounted device 100 may analyze the infrared image IRIMG based on the infrared data IRD corresponding to the infrared image IRIMG captured by the first sensing device 120. For example, the head mounted device 100 also includes a processor 140. The processor 140 is coupled to the display unit 110, the first sensing device 120, and the second sensing device 130. The head mounted device 100 may utilize the processor 140 to determine whether there is an object OBJ in the infrared image IRIMG that may cause harm to the user U. The object OBJ may be a pet, a person, a heat source, or an obstacle, but the disclosure is not limited thereto. The obstacle may be, for example, a furniture or a wall. When it is determined that there is an object OBJ causing harm to the user U in the infrared image IRIMG, it means that there is an object OBJ causing harm to the user U within the specific range PR. Therefore, the processor 140 notifies the second sensing device 130 to capture the object image OIMG of the object OBJ, and controls the display unit 110 to display the object image OIMG of the object OBJ.

It should be noted that the head mounted device 100 preferentially utilizes the first sensing device 120 to detect the environment around the user U. Therefore, the infrared image IRIMG shows the outline of the object around the user U, rather than showing the real visual appearance of the object around the user U. Therefore, the environment around user U is not leaked. The privacy of user U is ensured. Color interference from ambient light may be reduced. In addition, when the environment is dark, the head mounted device 100 may also determine whether there is an object OBJ causing harm to the user within the specific range PR.

In this embodiment, the head mounted device 100 may perform wired communication or wireless communication with the external device ED. The external device ED may be an electronic device with computing capabilities, such as a server, a host, a desktop computer, a laptop, a tablet, or a smartphone. The external device ED receives the infrared image IRIMG. The external device ED determines whether there is an object OBJ in the infrared image IRIMG that may cause harm to the user U. When it is determined that there is an object OBJ causing harm to the user U in the infrared image IRIMG, the external device ED notifies the second sensing device 130 to capture the object image OIMG of the object OBJ, and controls the display unit 110 to display the object image OIMG of the object OBJ. In some embodiments, the external device ED includes circuitry similar to the functionality of the processor 140.

The processor 140 is, for example, a central processing unit (CPU), or other programmable general-purpose or special-purpose microprocessor, a digital signal processor (DSP), a programmable controller, an application specific integrated circuit (ASIC), a programmable logic device (PLD), or other similar devices, or a combination of these devices, which may load and execute computer programs. The second sensing device 130 may be any form of visible light image capturing device (but the disclosure is not limited thereto). The second sensing device 130 may be implemented by, for example, a charge coupled device (CCD) or an under-display image capturing device (but the disclosure is not limited thereto).

In some embodiments, the processor 140 may be disposed inside the first sensing device of the head mounted device 100, alternatively, the processor 140 may be disposed on other electronic devices. The head mounted device 100 may transmit data to the processor 140 for processing through data transmission. Therefore, the first sensing device 120 itself may determine whether there is an object OBJ in the infrared image IRIMG that may cause harm to the user U without the help of an external device. It notifies the second sensing device 130 to capture the object image OIMG of the object OBJ, and controls the display unit 110 to display the object image OIMG of the object OBJ.

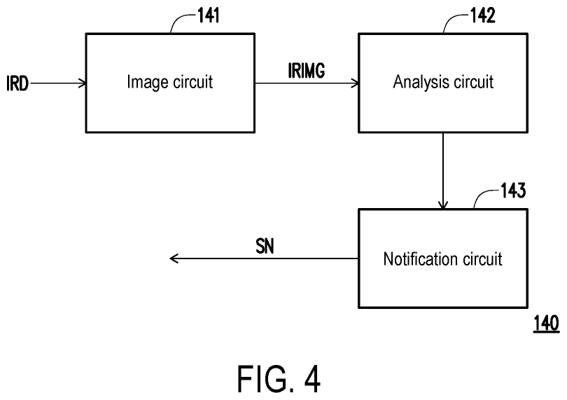

Referring to FIG. 2 and FIG. 4 at the same time, FIG. 4 is a schematic diagram of a processor according to an embodiment of the disclosure. In this embodiment, the processor 140 includes an image circuit 141, an analysis circuit 142, and a notification circuit 143. The image circuit 141 receives the infrared data IRD from the first sensing device 120 and renders the infrared data IRD into an infrared image IRIMG. The infrared image IRIMG may show the outline and temperature of the heat source around the user U.

The analysis circuit 142 is coupled to the image circuit 141 and the notification circuit 143. The analysis circuit 142 receives the infrared image IRIMG, and analyzes the infrared image IRIMG to determine whether there is an object OBJ causing harm to the user U within the specific range PR. When there is an object OBJ causing harm to the user U within the specific range PR, the analysis circuit 142 controls the notification circuit 143 to provide the notification signal SN. Therefore, the second sensing device 130 captures the object image OIMG of the object OBJ in response to the notification signal SN. The display unit 110 displays the object image OIMG of the object OBJ.

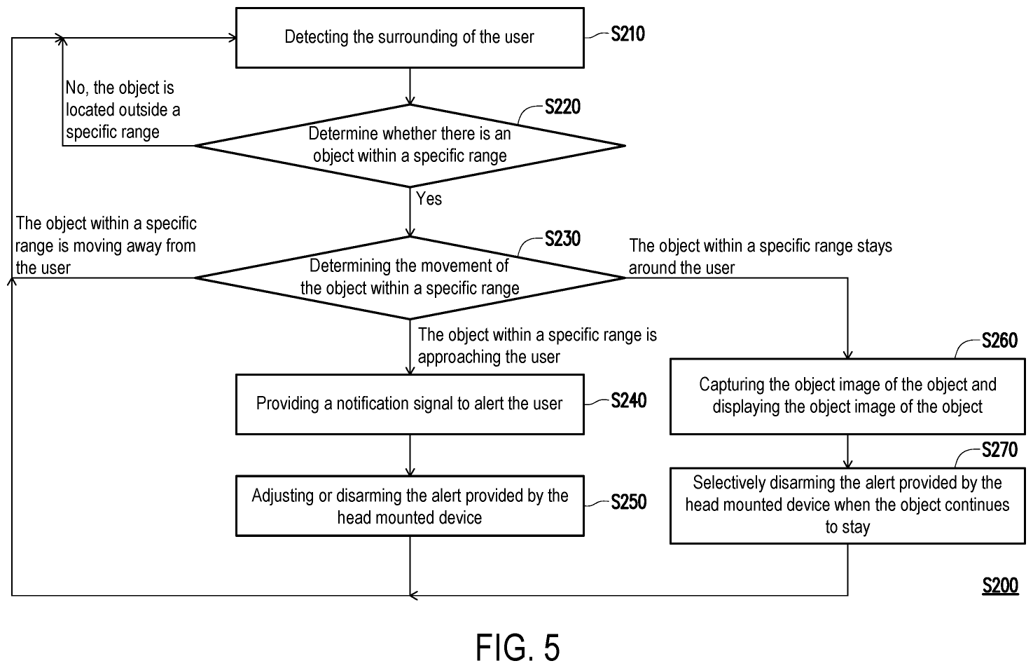

Referring to FIG. 1, FIG. 2, and FIG. 5 at the same time, FIG. 5 is a flowchart of an operating method according to another embodiment of the disclosure. The operating method S200 is configured for the head mounted device 100. The operating method S200 includes steps S210 to S270. The first sensing device 120 detects the surrounding of the user U in step S210. For example, in step S210, the first sensing device 120 detects the surrounding of the user U to provide infrared data IRD corresponding to the infrared image IRIMG.

In step S220, the processor 140 determines whether there is an object OBJ that may cause harm to the user U within the specific range PR. For example, in step S220, the processor 140 may determine whether there is an object OBJ within the specific range PR by using the infrared data IRD. When the object OBJ is located outside the specific range PR, the operating method S200 returns to the operation of step S210. Furthermore, when the object OBJ is located outside the specific range PR, the processor 140 stops providing the notification signal SN.

On the other hand, when the object OBJ is located within the specific range PR, the processor 140 further determines the movement of the object OBJ within the specific range PR in step S230.

In step S230, when the object OBJ within the specific range PR is moving away from the user U, the processor 140 determines that the object OBJ moving away from the user U will not cause harm to the user U. For example, the processor 140 determines that the outline of the infrared image IRIMG within the specific range PR becomes smaller rapidly. Therefore, the operating method S200 returns to the operation of step S210. Furthermore, when the object OBJ within the specific range PR is moving away from the user U, the processor 140 stops providing the notification signal SN.

In step S230, when the object OBJ within the specific range PR is approaching the user U, the processor 140 determines that the object OBJ approaching the user U will cause harm to the user U. For example, the processor 140 determines that the outline of the infrared image IRIMG within the specific range PR becomes larger rapidly. Therefore, the processor 140 provides the notification signal SN in step S240. Therefore, the head mounted device 100 alerts the user U based on the notification signal SN. For example, the display unit 110 may provide an alert light signal. When the object OBJ approaches the user U and its movement speed increases, the alert light signal becomes more obvious. For example, the flashing frequency or brightness of the alert light signal increases. In some embodiments, the head mounted device 100 may provide an alert sound to alert the user U in step S240. When the object OBJ approaches the user U and its movement speed increases, the alert sound becomes more obvious. For example, the tempo of the alert sound may increase or the volume may increase.

In addition, in step S240, the second sensing device 130 captures the object image OIMG of the object OBJ in response to the notification signal SN. The display unit 110 displays the object image OIMG of the object OBJ.

In step S250, the alert provided by the head mounted device 100 is adjusted or disarmed. For example, when the user U knows about that the object OBJ is approaching through the display unit 110, the user U may move away from the object OBJ or move the object OBJ to a safe region. Therefore, the user U disarms the alert through the head mounted device 100. For example, when the user U knows about through the display unit 110 that the approaching object OBJ will not cause harm, the user U adjusts the alert conditions through the head mounted device 100. Therefore, the processor 140 may learn about the infrared image of the object OBJ that does not cause harm. For example, when the user U knows about through the display unit 110 that the specific range PR needs to be adjusted, the user U adjusts the specific range PR through the head mounted device 100. Therefore, the alert conditions are also adjusted.

After step S250, the operating method S200 returns to the operation of step S210.

In step S230, when the object OBJ within the specific range PR does not approach or move away from the user U, this means that the object OBJ stays around the user U without moving. For example, the processor 140 determines that the size of the outline of the infrared image IRIMG within the specific range PR has not changed. Therefore, the processor 140 provides the notification signal SN in step S260. The second sensing device 130 captures the object image OIMG of the object OBJ in response to the notification signal SN. The display unit 110 displays the object image OIMG of the object OBJ. In addition, the head mounted device 100 alerts the user U based on the notification signal SN.

In step S270, when the object OBJ continues to stay, the user U may selectively disarm the alert provided by the head mounted device 100.

After step S270, the operating method S200 returns to the operation of step S210.

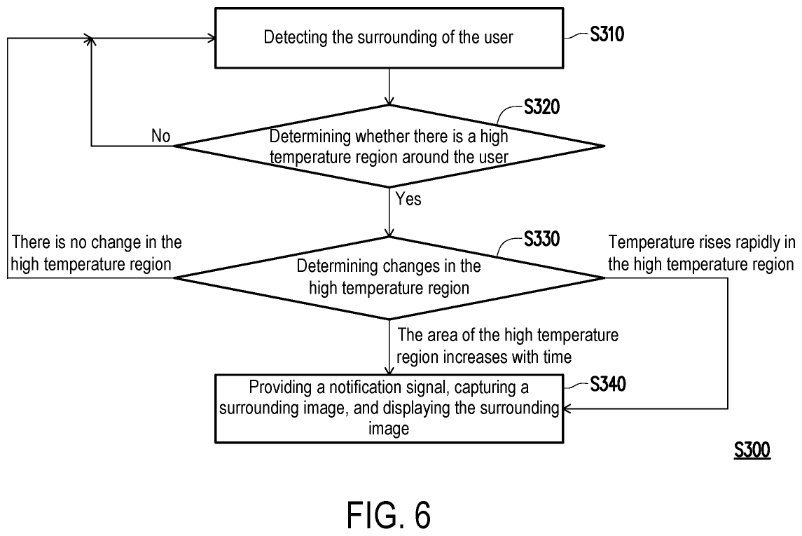

Referring to FIG. 1, FIG. 2, and FIG. 6 at the same time, FIG. 6 is a flowchart of an operating method according to an embodiment of the disclosure. The operating method S300 is configured for the head mounted device 100. The operating method S300 includes steps S310 to S350. The first sensing device 120 detects the surrounding of the user U in step S310. For example, in step S310, the first sensing device 120 detects the surrounding of the user U to provide infrared data IRD corresponding to the infrared image IRIMG.

In step S320, the processor 140 determines whether there is a high temperature region around the user U. The high temperature region is, for example, a heat source having a temperature greater than a predetermined temperature. In step S320, the processor 140 may determine whether there is a high temperature region around the user U by using the infrared data IRD. When there is no high temperature region around the user U, the operating method S300 returns to the operation of step S310.

On the other hand, when there is a high temperature region around the user U, the processor 140 further determines changes in the high temperature region in step S330.

In step S330, when the high temperature region does not change over time, this means that the high temperature region may be a fixed heat source (e.g., a heater or an electric lamp). Therefore, the processor 140 does not provide the notification signal SN. The operating method S300 returns to the operation of step S310.

In step S330, when the area of the high temperature region increases with time, it means that the heat source is gradually approaching the user U or the heat source is expanding. Therefore, the processor 140 provides the notification signal SN in step S340. Therefore, the head mounted device 100 alerts the user U based on the notification signal SN. The second sensing device 130 captures a surrounding image in response to the notification signal SN. The display unit 110 displays the surrounding image.

In addition, when the temperature of the high temperature region increases rapidly, the processor 140 also provides the notification signal SN in step S340. The head mounted device 100 alerts the user U. The second sensing device 130 captures the surrounding image. The display unit 110 displays the surrounding image.

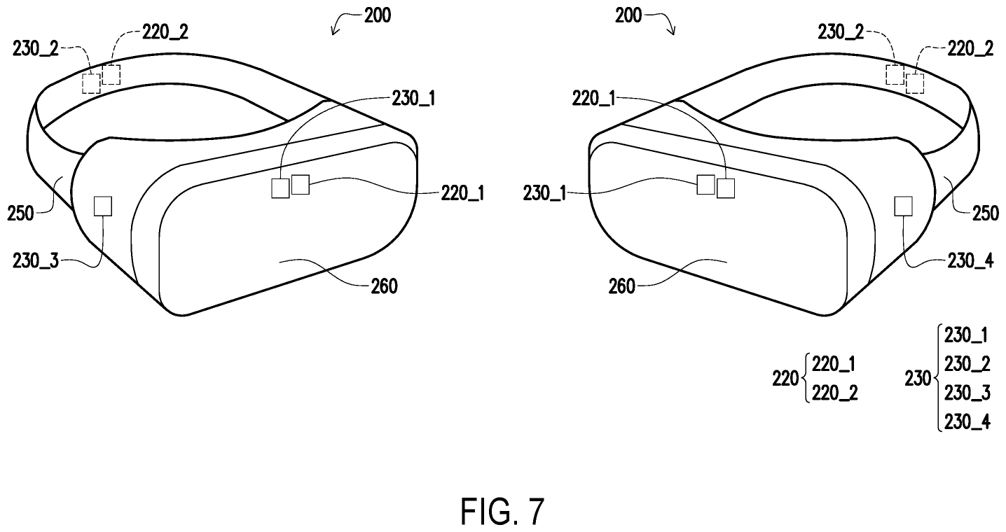

Referring to FIG. 1 and FIG. 7 at the same time, FIG. 7 is a schematic diagram of a head mounted device according to an embodiment of the disclosure. FIG. 7 shows a schematic diagram of the head mounted device 200 from different viewing angles. In this embodiment, the head mounted device 200 includes a display unit (not shown), a first sensing device 220, a second sensing device 230, a headband 250, and an eye mask 260. The display unit is disposed on the eye mask 260. The head mounted device 200 may be worn on the head of the user U through the headband 250. The first sensing device 220 includes first sensors 220_1 and 220_2. The second sensing device 230 includes second sensors 230_1 to 230_4. In this embodiment, the first sensors 220_1 and 220_2 are disposed on the headband 250 and the eye mask 260. The second sensors 230_1 to 230_4 are disposed on the headband 250 and the eye mask 260.

Taking this embodiment as an example, the first sensor 220_1 is disposed on the front surface of the eye mask 260. The first sensor 220_2 is disposed on the headband 250. When the user U wears the head mounted device 200, the first sensor 220_1 detects toward the front of the user U. The first sensor 220_2 detects toward the rear of the user U.

The second sensor 230_1 is disposed on the front surface of the eye mask 260. The second sensor 230_2 is disposed on the headband 250. The second sensor 230_3 is disposed on the left surface of the eye mask 260. The second sensor 230_4 is disposed on the right surface of the eye mask 260.

Taking this embodiment as an example, the detectable angle (or viewing angle) of the first sensors 220_1 and 220_2 is approximately 180°. The detectable angle of the second sensors 230_1 to 230_4 may be approximately 120°. Based on the configuration of FIG. 7, the first sensing device 220 may detect the infrared image around the user U. The second sensing device 230 may capture the visible light image around the user U.

This embodiment takes two first sensors 220_1 and 220_2 and four second sensors 230_1 to 230_4 as an example, but the disclosure is not limited thereto. The disclosure may determine the placement position of the first sensor and the number of the first sensor based on the detectable angle and/or the detectable wavelength of the first sensor. The disclosure may determine the placement position of the second sensor and the number of the second sensor based on the detectable angle of the second sensor.

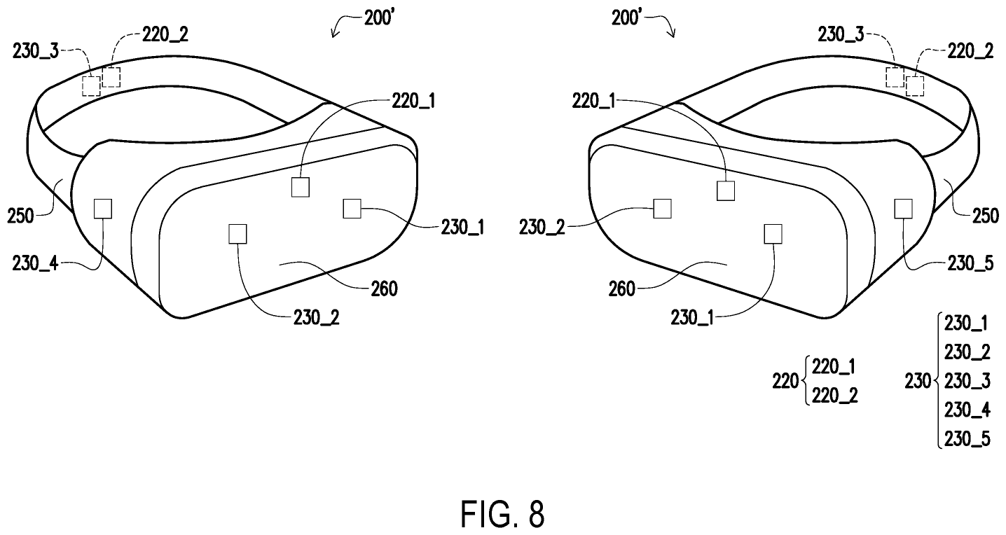

Referring to FIG. 1 and FIG. 8 at the same time, FIG. 8 is a schematic diagram of a head mounted device according to an embodiment of the disclosure. In this embodiment, the head mounted device 200′ includes a display unit (not shown), a first sensing device 220, a second sensing device 230, a headband 250, and an eye mask 260. The first sensing device 220 includes first sensors 220_1 and 220_2. The second sensing device 230 includes second sensors 230_1 to 230_5.

Taking this embodiment as an example, the first sensor 220_1 is disposed on the front surface of the eye mask 260. The first sensor 220_2 is disposed on the headband 250. When the user U wears the head mounted device 200, the first sensor 220_1 detects toward the front of the user U. The first sensor 220_2 detects toward the rear of the user U.

The second sensors 230_1 and 230_2 are disposed on the front surface of the eye mask 260. The second sensor 230_1 is disposed on the eye mask 260 at a position corresponding to the left eye of the user U. The second sensor 230_2 is disposed on the eye mask 260 at a position corresponding to the right eye of the user U.

The second sensor 230_3 is disposed on the headband 250. The second sensor 230_4 is disposed on the right surface of the eye mask 260. The second sensor 230_5 is disposed on the left surface of the eye mask 260.

Based on the configuration of FIG. 8, the first sensing device 220 may detect the infrared image around the user U. The second sensing device 230 may capture the visible light image around the user U.

In addition, it should be noted that the disposed positions of the second sensors 230_1 and 230_2 correspond to the positions of both eyes of the user U. The visible light images captured by the second sensors 230_1 and 230_2 help generate a three-dimensional image.

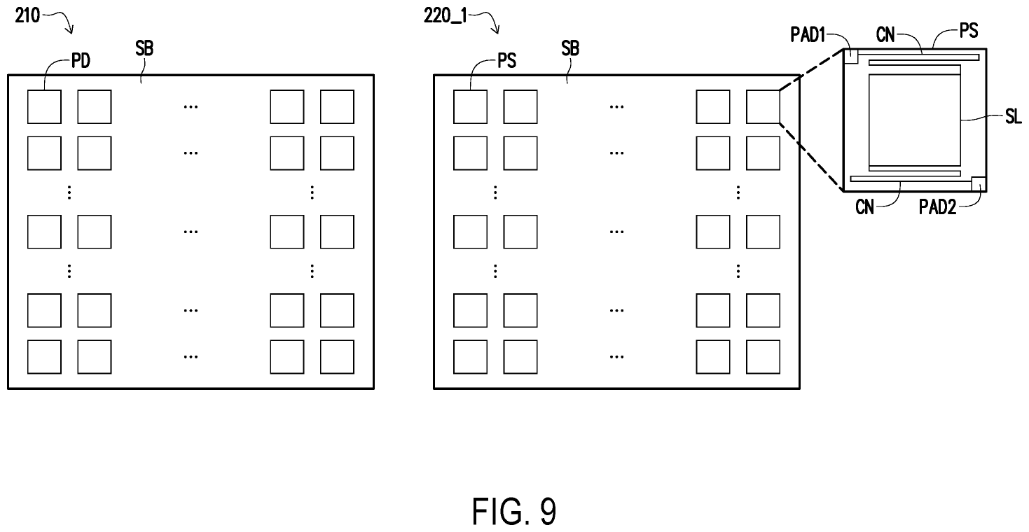

Referring to FIG. 9, FIG. 9 is a schematic diagram of a display unit and a first sensor according to an embodiment of the disclosure. In this embodiment, FIG. 9 shows the display unit 210 and the first sensor 220_1. In this embodiment, the display unit 210 includes multiple display pixels PD and a substrate SB. The display pixels PD are disposed on the substrate SB. The first sensor 220_1 includes multiple sensing pixels PS. The sensing pixels PS may be disposed in an array on the substrate SB. In other words, the first sensor 220_1 and the display pixels PD of the display unit 210 are disposed on the same substrate SB.

In this embodiment, the display unit 210 is a transparent display panel. The substrate SB may be a glass substrate (but the disclosure is not limited thereto). In some embodiments, the substrate SB may be a flexible substrate. In this embodiment, the layout positions of the display pixels PD are substantially the same as the layout positions of the sensing pixels PS. In addition, the size and position of the display pixels PD are substantially the same as the size of the sensing pixels PS. Therefore, corresponding regions between the display pixels PD and the sensing pixels PS may have transparency.

In this embodiment, the transparency of the display unit 210 is adjusted so that the user may view the external environment through the display unit 210. In this way, the user may view the external environment without taking off the head mounted device.

In this embodiment, each of the sensing pixels PS is a micro electro mechanical (MEM) structure. The sensing pixels PS may each include pads PAD1 and PAD2, a resistive structure CN, and a sensing structure SL. The resistive structure CN is electrically connected to the pads PAD1 and PAD2. The sensing structure SL partially covers the resistive structure CN and is in contact with the resistive structure CN. The sensing structure SL may change the impedance value of the resistive structure CN according to infrared. The sensing structure SL may be a heat-absorbing structure, metal, or a material that easily absorbs the infrared band. The first sensor 220_1 provides infrared data corresponding to the infrared image (infrared data IRD of the infrared image IRIMG shown in FIG. 2) according to changes in the impedance value. The first sensor 220_1 can, for example, receive the signal current generated by the impedance change of the sensing pixel PS through the pads PAD1 and PAD2.

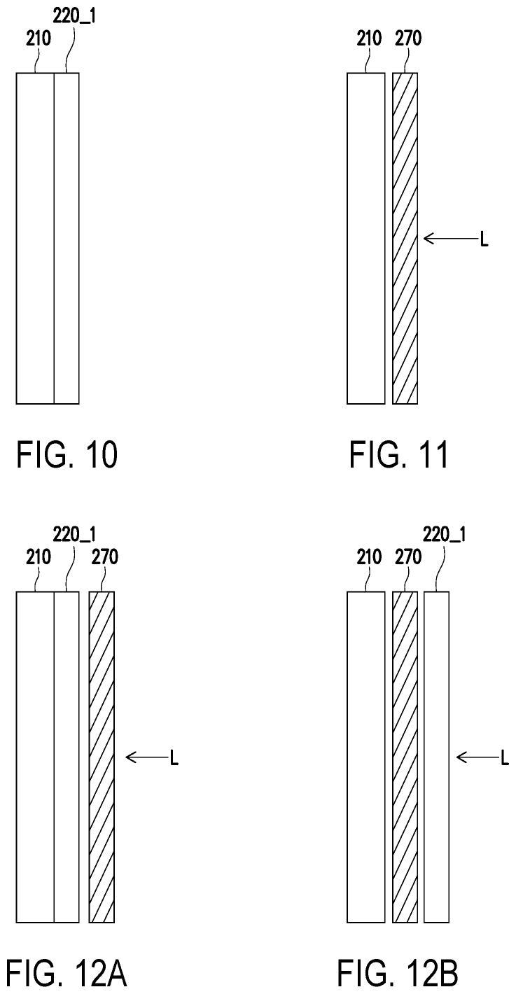

Referring to FIG. 9 and FIG. 10 at the same time, FIG. 10 is a schematic diagram of a display unit and a first sensor according to an embodiment of the disclosure. In this embodiment, FIG. 10 shows the display unit 210 and the first sensor 220_1. The first sensor 220_1 is attached to the display unit 210. For example, the display pixels PD are disposed on the first side of the substrate SB. The first sensor 220_1 is attached on the second side of the substrate SB. The second side is opposite to the first side. The positions of the display pixels PD correspond to the positions of the sensing pixels PS. Therefore, the region between the display pixels PD has transparency.

Referring to FIG. 7 and FIG. 11 at the same time, FIG. 11 is a schematic diagram of a display unit and a mask according to an embodiment of the disclosure. In this embodiment, the head mounted device 200 further includes a mask 270. The display unit 210 is a transparent display panel. The mask 270 is operated to cover the display unit 210. Therefore, the mask 270 may block the light L from the external environment. The immersive experience of the head mounted device 200 may be enhanced. On the other hand, the mask 270 is moved to not cover the display unit 210. The light L from the external environment penetrates the display unit 210. Therefore, the user views the external environment through the display unit 210.

Referring to FIG. 9 and FIG. 12A at the same time, FIG. 10 is a schematic diagram of a display unit, a first sensor, and a mask according to an embodiment of the disclosure. In this embodiment, the head mounted device 200 further includes a mask 270. The display unit 210 is a transparent display panel. The first sensor 220_1 is attached to the display unit 210. There may be transparency between the display pixels PD and the sensing pixels PS. The light L from the external environment may penetrate the first sensor 220_1 and the display unit 210.

In this embodiment, the mask 270 is operated to cover the display unit 210 and the first sensor 220_1, thereby blocking the light L from the external environment. Therefore, the immersive experience of the head mounted device 200 may be enhanced. On the other hand, the mask 270 is moved to not cover the display unit 210. The light L from the external environment penetrates the display unit 210 and the first sensor 220_1. Therefore, the user may view the external environment through the display unit 210 and the first sensor 220_1.

Referring to FIG. 9 and FIG. 12B at the same time, FIG. 10 is a schematic diagram of a display unit, a first sensor, and a mask according to an embodiment of the disclosure. In this embodiment, the display unit 210 is a transparent display panel. The first sensor 220_1 is not attached to the display unit 210. However, the positions of the display pixels PD correspond to the positions of the sensing pixels PS. Therefore, the light L from the external environment may still penetrate the first sensor 220_1 and the display unit 210. When the mask 270 is operated to cover the display unit 210, the mask 270 is located between the first sensor 220_1 and the display unit 210. The mask 270 may block the light L from the external environment. The immersive experience of the head mounted device 200 may be enhanced. On the other hand, the mask 270 is moved to not cover the display unit 210. The light L from the external environment penetrates the display unit 210. Therefore, the user may view the external environment through the display unit 210 and the first sensor 220_1.

To sum up, whether there is an object causing harm to the user within a specific range is detected by the first sensing device. When an object causing harm to the user within the specific range is detected, the display unit displays the object image of the object. In this way, the head mounted device may know about that there is an object causing harm to the user within a specific range, and display the object image of the object through the display unit. The usage safety of the head mounted device may be improved. Furthermore, in one embodiment, the first sensing device is an infrared detection device. The head mounted device detects the environment around the user by preferentially using the first sensing device. The infrared image shows the outline of the object around the user, but does not show the real visual appearance of the object around the user. Therefore, the environment around user is not leaked. The privacy of user is ensured. In addition, when the environment is dark, the head mounted device may also determine whether there is an object causing harm to the user within the specific range.

Finally, it should be noted that the foregoing embodiments are only used to illustrate the technical solutions of the disclosure, but not to limit the disclosure; although the disclosure has been described in detail with reference to the foregoing embodiments, persons of ordinary skill in the art should understand that the technical solutions described in the foregoing embodiments may still be modified, or parts or all of the technical features thereof may be equivalently replaced; however, these modifications or substitutions do not deviate the essence of the corresponding technical solutions from the scope of the technical solutions of the embodiments of the disclosure.

What is claimed is:

1. A head mounted device, wherein the head mounted device is worn on a user and provides an image to the user, wherein the head mounted device comprises:
a display unit, configured to display the image;
a first sensing device, configured to detect whether there is an object causing harm to the user within a specific range; and
a second sensing device, configured to capture an object image of the object, so that the display unit displays the object image.

2. The head mounted device according to claim 1, wherein the first sensing device is an infrared detection device.

3. The head mounted device according to claim 1, wherein a physical activity range of the user is set to the specific range.

4. The head mounted device according to claim 1, wherein:
the head mounted device further comprises a headband and an eye mask,
the first sensing device comprises a plurality of first sensors,
the second sensing device comprises a plurality of second sensors,
the first sensors are disposed on the headband and the eye mask, and
the second sensors are disposed on the headband and the eye mask.

5. The head mounted device according to claim 4, wherein:
one of the second sensors is disposed at a position of the eye mask corresponding to a left eye of the user, and
another one of the second sensors is disposed at a position of the eye mask corresponding to a right eye of the user.

6. The head mounted device according to claim 4, wherein at least one of the first sensors and a plurality of display pixels of the display unit are disposed on a same substrate.

7. The head mounted device according to claim 4, wherein at least one of the first sensors is attached to the display unit.

8. The head mounted device according to claim 1, wherein:
the display unit is a transparent display panel,
transparency of the display unit is adjusted so that the user may view an external environment through the display unit.

9. The head mounted device according to claim 8, wherein the head mounted device further comprises:
a mask, operated to cover the display unit to block light from the external environment, and moved to not cover the display unit so that the light from the external environment penetrates the display unit.

10. The head mounted device according to claim 1, wherein the head mounted device further comprises:
a processor, coupled to the display unit, the first sensing device, and the second sensing device, and configured to determine whether there is the object causing harm to the user in an infrared image from the first sensing device.

11. The head mounted device according to claim 10, wherein the processor determines that the object moving away from the user does not cause harm to the user when the object within the specific range is moving away from the user.

12. The head mounted device according to claim 10, wherein the processor determines that the object approaching the user does not cause harm to the user when the object within the specific range is approaching the user.

13. An operating method for a head mounted device, wherein the head mounted device is worn on a user and provides an image to the user, wherein the head mounted device comprises a display unit, a first sensing device, and a second sensing device, wherein the operating method comprises:
detecting whether there is an object causing harm to the user within a specific range by the first sensing device;
capturing an object image of the object by the second sensing device when the object causing harm to the user is detected within the specific range; and
controlling the display unit to display the object image.

14. The operating method according to claim 13, wherein the first sensing device is an infrared detection device.

15. The operating method according to claim 13, wherein a physical activity range of the user is set to the specific range.

16. The operating method according to claim 13, wherein detecting whether there is the object causing harm to the user within the specific range by the first sensing device comprises:
determining that the object moving away from the user does not cause harm to the user when the object within the specific range is moving away from the user.

17. The operating method according to claim 13, wherein detecting whether there is the object causing harm to the user within the specific range by the first sensing device comprises:
determining that the object approaching the user does not cause harm to the user when the object within the specific range is approaching the user.

18. The operating method according to claim 13, further comprising:
determining a change in a high temperature region when there is the high temperature region around the user.

19. The operating method according to claim 18, further comprising:
providing a notification signal when an area of the high temperature region increases with time; and
in response to the notification signal, capturing a surrounding image by the second sensing device.

20. The operating method according to claim 18, further comprising:
providing a notification signal when a temperature in the high temperature region increases rapidly; and
in response to the notification signal, capturing a surrounding image by the second sensing device.
